(19) United States
(12) Patent Application Publication
(10) Pub. No.: US 2006/0231333 A1
(43) Pub. Date: Oct. 19, 2006

(54) Ladder accessories

(76) Inventor: Pierre Proulx, Stoke (CA)

Correspondence Address: OGILVY RENAULT LLP, 1981 MCGILL COLLEGE AVENUE, SUITE 1600, MONTREAL, QC, H3A2Y3, CA

(21) Appl. No.: 11/108,808

(22) Filed: Apr. 19, 2005

(51) Int. Cl. E06C 7/42

(52) U.S. Cl. 182/107

(57) ABSTRACT

Molded accessories for ladders, more particularly, a standoff device and a suspended container. The molded standoff device for spacing a ladder from a work surface, comprises: a structural panel element having a panel attachment securable onto a first rung of the ladder, and at least two work surface contact areas spaced apart along a transverse axis to the ladder, opposite the attachment means; and at least one structural arm element separable from the panel element and having an attachment portion securable onto a second rung of the ladder such that the standoff device will be rigidly secured to the ladder. The suspended container is made of two elements, the container which is secured to a lower rung, and an arm member which secures the back wall of the container to an upper rung.

### CROSS-REFERENCE TO RELATED APPLICATIONS

This application is related to U.S. Pat. No. 6,431,509, entitled “Paint Can Holder”, filed Oct. 13, 2000, by applicant, the contents of which are hereby incorporated by reference.

### BACKGROUND OF THE INVENTION

1) Field of the Invention

The invention relates generally to molded accessories for ladders, and more particularly to a molded ladder standoff device, and to a suspended molded ladder container.

2) Description of the Prior Art

Ladder supports or standoff devices for spacing a ladder from a work surface have been used for more than a century. For example, J. G. Ellinger presented a ladder support in U.S. Pat. No. 799,782. The adaptation to different angles of work surfaces was achieved by extending and retracting telescopic arms to change the position of an abutment structure. It comprised many components.

A fixed ladder standoff device has been presented most recently by Lonnie Coulson in U.S. Pat. No. 6,681,893. In fact Coulson also uses a fixed support structure held within hollow rungs of a ladder. It had a double wheel and pivot assembly provided at each leg which allowed the fixed structure to adapt to different angles of work surfaces. To use the device on ladders which do not comprise hollow rungs, Coulson teaches the use of brackets fixed through holes drilled in the stiles.

The ladder standoff device presented by S. Butcher et Al. in U.S. Pat. No. 2,432,189, provides a removable structure made of one piece, its curved support area provides for spacing the ladder work surfaces such as a 45° inclined roof. However, this device is not suited for spacing the ladder from a horizontal roof. Its structure takes up much storage space when not in use.

L. R. Sitek presents a safety ladder basket in U.S. Pat. No. 2,597,756 which consists of a metal container held at one side by two hooks onto a rung of a ladder, and where the other side is held to a superior rung by a strap affixed by nuts and screws.

Due to the insufficiencies of the prior art, there remains a need for an improved device for spacing a ladder from a work surface.

### SUMMARY OF THE INVENTION

It is an object of the invention to provide a ladder standoff device which is both structurally resistant and made of molded components.

It is another object of the invention to provide a ladder standoff device which is easily installable and removable from a ladder structure.

It is another object of the invention to provide a ladder standoff device which is adapted to be disassembled into two or more components for providing a compact configuration for transportation and storage.

It is another object of the invention to provide a low cost standoff device.

One aspect of the invention provides a molded standoff device for spacing a ladder from a work surface, the device comprising: a structural panel element having a panel attachment securable onto a first rung of the ladder, and at least two work surface contact areas spaced apart along a transverse axis to said ladder, opposite the attachment means; and at least one structural arm element separably connected to the panel element and having an attachment portion securable onto a second rung of the ladder such that the standoff device will be rigidly secured to the ladder.

One other aspect of the invention provides a molded container for use on a ladder, comprising: a receptacle element; at least one attachment for securing a first wall of the receptacle to a lower rung of the ladder; an arm, separable from the receptacle element, for securing a second wall of the receptacle, opposite the first wall, to an upper rung of the ladder; whereby the receptacle is stably suspended to the rungs of the ladder by the arm and the receptacle attachment when the ladder is in use.

One further aspect of the invention provides a removable standoff device for a ladder comprising: a standoff device body having a first attachment means for removably attaching the standoff device body onto a rung of the ladder and at least two abutting means spaced apart along an abutment axis, for abutting against a work surface; and arm means secured to the standoff device body, between the first attachment means and the abutting means, for rigidly securing the standoff device body to another rung of the ladder, whereby the abutment axis is maintained spaced from the ladder by the standoff device.

### BRIEF DESCRIPTION OF THE DRAWINGS

Further features and advantages of the present invention will become apparent from the following detailed description, taken in combination with the appended drawings, in which:

FIG. 1 includes FIG. 1A and FIG. 1B which are perspective views of a standoff device in accordance with a first embodiment of the present invention, shown mounted on a ladder and in use against different work surfaces.

FIG. 2 is a side elevation view of a panel element of the standoff device of FIG. 1.

FIG. 3 is a front elevation view of the panel element of FIG. 2.

FIG. 4A is a side elevation view of an arm element of the standoff device of FIG. 1.

FIG. 4B is a bottom plan view of the arm element shown in FIG. 4A.

FIG. 5 is a perspective view of a suspended ladder container in accordance with a second embodiment of the present invention, shown on a ladder which is in use against a wall.

FIG. 6 is a perspective view of the receptacle element of the ladder container of FIG. 5.

FIG. 7 is a perspective view of the arm of the ladder container of FIG. 5.

### DETAILED DESCRIPTION OF THE PREFERRED EMBODIMENT

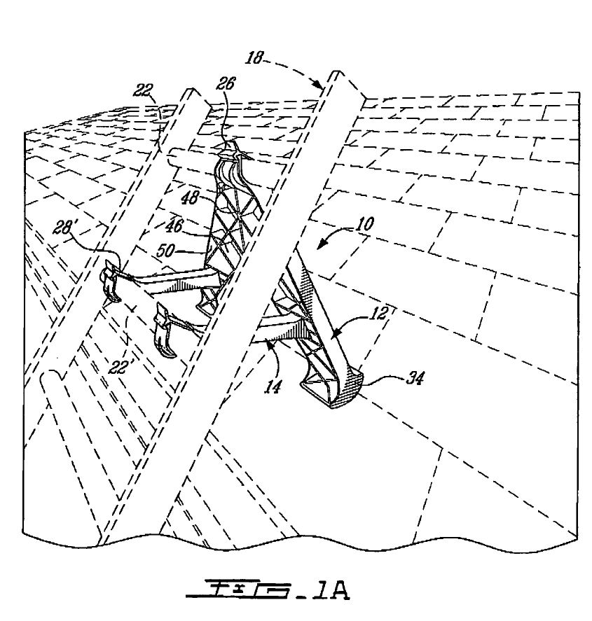

With reference to FIGS. 1A to 4B, it will be seen a first embodiment of the present invention is illustrated which is a standoff device for spacing a ladder from a work surface in accordance with a preferred embodiment.

In FIGS. 1A and 1B, the standoff device 10 is shown secured to a ladder 18. In FIG. 1A, the ladder 18 with the standoff device 10 is shown in its preferred use, spacing the ladder 18 from an inclined roof having a gutter at the edge. This allows one to service the gutter without the ladder pushing against it and potentially damaging it. In FIG. 1B, the ladder 18 with the standoff device 10 is shown in an operating position, against a wall, being spaced therefrom by means of the device 10. This allows one to reach the window more easily, especially since the ladder 18 must not be placed against the glass. It is to be noted that the configuration of the standoff device 10 allow the ladder to be spaced from other types of work surfaces as well, such as, for example, a roof of any given angle between horizontal and vertical, or even a corner of a roof or a wall, these are some advantages of the preferred embodiment of the device. Horizontal roves, for example, typically have aluminum edges which are known to be susceptible to damage by ladders when the force is exerted by a man climbing the ladder. Use of the standoff device 10 in such a situation overcomes this inconvenience.

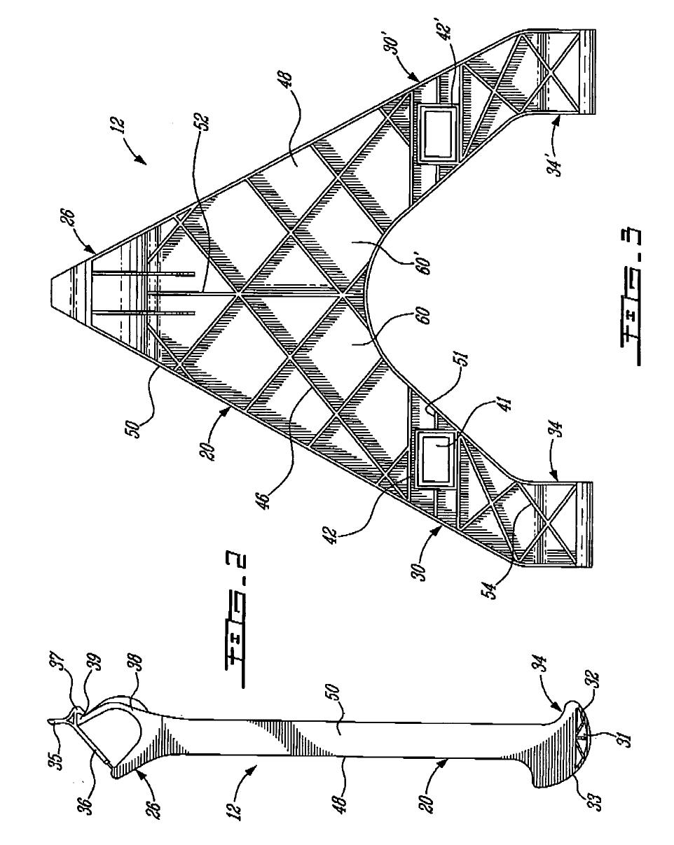

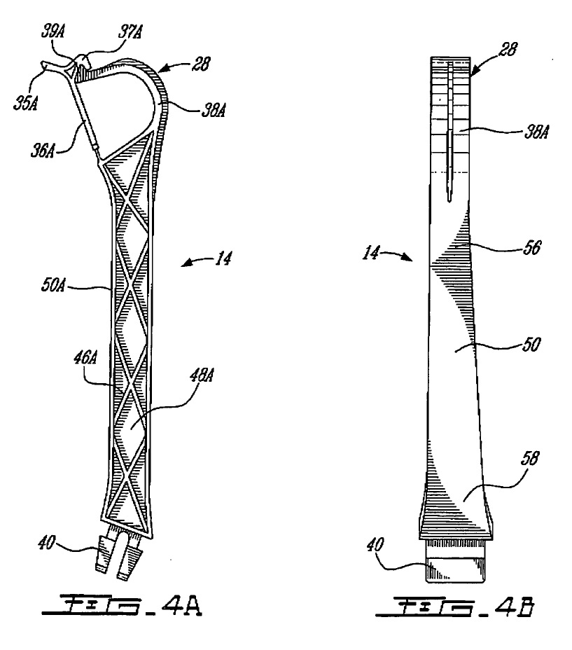

The standoff device 10 comprises a triangular panel member 12 that has a first releasable panel attachment 26 at the apex, for securing it onto a first rung 22 of the ladder, and also comprises two feet 34 and 34′ which have work surface contact areas designed to abut the work surface. The preferred standoff device 10 also includes two arm elements 14, 14′ which are secured to the triangular panel element 12 at a position intermediate between the panel attachment 26 and the feet 34, 34′. The arm elements 14, 14′ are secured onto a second rung 22′ of the ladder 18 by arm attachment portions 28, 28′, at their respective ends opposite to the panel element 12. The arm elements 14, 14′ are spaced from one another along the rung 22′ to achieve a stable and secure attachment of the standoff device to the ladder. The arm elements 14, 14′ are secured to panel joints 42, 42′ respectively located towards opposite edges of the panel element 12 (shown in FIG. 3) by arm joints 40, 40′ (shown in FIGS. 4A and 4B).

Alternatively, as it will be detailed further on, the standoff device 10 may be used with a tray (not illustrated) mounted thereon. Such a tray is preferably generally rectangular and has two lateral shoulders. Each opposite shoulder is placed upon a corresponding arm element and thus together, they support the tray which extends between the arm elements. The tray is optional and is not part of the standoff device structure, but which nevertheless has the feature of being adapted to receive such a tray.

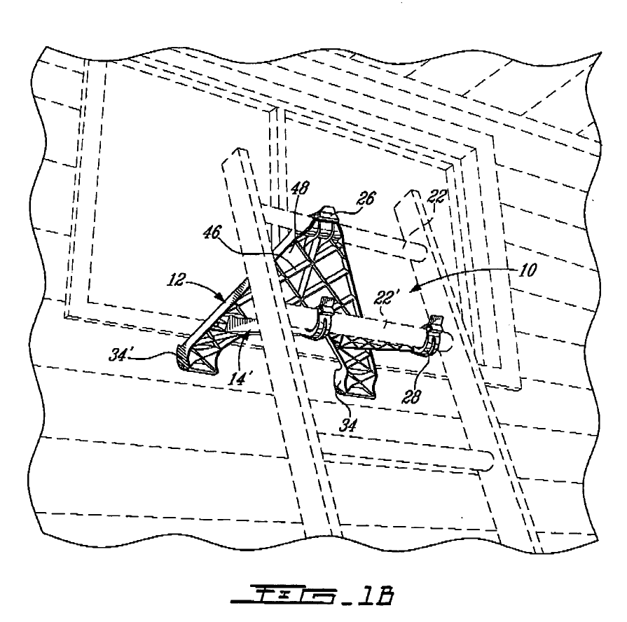

The panel element 12 is better detailed in FIGS. 2 and 3, where it is shown disassembled. FIG. 3 shows that the feet 34, 34′ of panel element 12 are spaced apart one another along a transverse axis to the ladder, which will be seen to be parallel to the rungs. The panel element 12 has a generally isosceles triangular shape, with the panel attachment 26 coinciding with the apex of the isosceles triangle and the transverse axis along which the feet are spaced coinciding more or less with the base of the isosceles triangle. The side view in FIG. 2 shows that the releasable panel attachment 26 is similar to the one presented by applicant at the lower portion of the paint can holder in U.S. Pat. No. 6,431,509. The panel attachment 26 includes two parts, namely a lower upwardly curving strip 38 which has a catch 37 at its end, and an upper straight strip 36 which is formed with an inwardly turned hook 39 at its outer end. It will be seen that hook 39 is capable of snappingly engaging the catch 37 when a rung 22 is engaged between the upper and lower strips 36 and 38, such that the rung 22 is secured therebetween. The panel attachment 26 also includes a lever 35 which is used to disengage the catch 37 from the hook 39 and to remove the panel attachment 26 from engagement with the rung 22. However, since the preferred panel element 12 only has one such attachment member 26 to secure it to the rung 22, which is a consequence of its preferred triangular shape described above, the panel attachment 26 is made wider than the one of the paint can holder (see FIG. 3). This provides extra rigidity and stability. It will be seen that the attachment portions 28, 28′ of the arm elements 14, 14′ are of the same type, but need not be as wide since two arm attachment portions 28, 28′ are used to provide stability.

Still in FIG. 2, it is seen that a main body portion 20 of the panel element 12 is defined between the panel attachment 26 and the feet 34, 34′. The main body portion 20 is generally of constant thickness, although it consists of a flat base 48 and flanges 46, 50, 51 and 52, which are shown in FIG. 3 and will be discussed further down. The body portion 20 is relatively straight in side view except for the lower portion which is curved before the feet 34, 34′ to give a proper predetermined orientation of the contact surfaces to span between vertical and horizontal directions when the standoff device 10 is mounted to a ladder 18 and the ladder 18 is put into operation against a work surface. The contact portions of the feet 34, 34′ preferably have a transversal semi-circular shape which spans an angle of at least 90 degrees such as to span from the horizontal to the vertical plane when in operation as described above. In this manner, any angle of work surface between horizontal and vertical may be accommodated by the soft curve of the semi-circular shaped contact portions of the feet 34, 34′.

As will be seen, the structure of the elements 12, 14, 14′ of the standoff device 10 are designed to be molded out of a plastics material. The preferred material is polypropylene which provide a desired elasticity of the structure at operating temperatures. The advantages of providing the stand-off device 10 in molded components is that molded products are particularly suitable for large scale production such that once the mold is obtained, the individual parts are cheaper to produce. The task of engineering structural components of molded materials demands attention to particular considerations when the objective is to reduce the amount of material used. In the preferred embodiment, with reference to FIG. 3, it will be seen that the particular configuration of flanges 46, 50, 51, 52, and base panel 48 defining the panel element 12 were engineered to provide a high structural resistance and durability, adapted to the particular use for the product, while minimizing the amount of material present in each device to reduce the unitary cost and weight.

As shown in FIG. 3 and FIG. 1, the body portion 20 of the panel element 12 includes a base panel 48 which is flat on both sides and is located outwardly from the ladder 18 when in use, and flanges 46, 50, 51, 52 of equal height extending inwardly from the inner side of the panel element 12 at a 90° angle therewith. The outer face of the base panel 48 can therefore be used to include advertising on the device 10 whereas the flanges 46, 50, 51, 52 extend inwardly from the base panel 48 towards the ladder side. Preferably, an outer flange 50 of a calculated thickness surrounds the entire body portion 20 of the panel element 12. Inner flanges 46 are disposed at predetermined angles and locations to provide structural strength to the panel element 12. As shown, the inner flanges 46 are generally disposed in two intersecting series at angles of about 45°, spanning across the entire face of the base panel 48. There is also a middle flange 52 which is located at the center of the panel element 12, defining two panel sides 60, 60′. Other special flanges provided include joint reinforcement flanges 51 provided at each side of the square openings, defining the panel joints 42, 42′ where the arm elements 14, 14′ are secured to the panel element 12, and those extending from the lower lip of the panel attachment 26, which provide extra rigidity of the structure.

The preferred design minimizes the quantity of material necessary to achieve an optimal rigidity. This is the reason of the flange 46, 50, 52 and base panel 48 construction. As it is shown in FIGS. 2 and 3, the feet 34, 34′ also have been designed to use as little material possible, while maintaining the desired rigidity. Flanges 32, 54 extend throughout both the width and length of the feet. In FIG. 2, it is seen that small holes 31 defining flanges 32 extend transversally through the width of each foot, at the bottom. Flanges 32 and 54 are designed to enhance the advantages of the standoff device 10.

As illustrated in FIG. 3, the preferred shape of the panel element 12 is triangular, with the apex of the triangle being the attachment member 26 previously described. The base of the triangle being the axis transversal to the ladder along which are spaced the two feet. FIG. 3 further illustrates the preferred arch shape extending inwardly from the feet 34, 34′ of the panel element, or from the base of the triangle. In fact, this preferred arch defines two legs 30, 30′, at each end of which is disposed the corresponding foot 34, 34′. When the device is in use, the arch allows one to position the ladder with the standoff device 10 against a corner of a wall or of a roof. In this use, one leg 30, 30′ (and one foot 34, 34′) is disposed at each side of the corner, and the corner extends within the arch. Hence, each foot 34, 34′ is against a different wall of the corner and maintains the ladder 18 spaced therefrom. The square opening 41, 41′ defining the panel joint 42, 42′ to the arm element 14, 14′ is located within each leg 30, 30′. As it will be shown, the square openings 41, 41′ serve as a female joint 42, 42′ for receiving the male arm joints 40, 40′ (FIGS. 4A and 4B).

Turning now to FIGS. 4A and 4B, where a preferred right side arm element 14′ is illustrated, it can be seen that the preferred right arm element 14′ is designed somewhat similarly to the structural element to the extent that it also has a base panel 48A, a surrounding external flange 50A, and intersecting internal flanges 46A, to optimize structural resistance with a minimal quantity of material. The arm attachment portion 28′ is very similar to the panel attachment 26 and comprises the same components described above although it is not made as wide and has parallel sides. Special attention may be taken here to the male arm joint 40 located at the end of the arm element 14′ which is opposed to the arm attachment 28′. It can be seen that the preferred arm joint 40′ has two opposed clips extending outwardly from one another and separated by an empty space designed to provide elasticity. Hence, the arm joint 40′ is snapped into place within the corresponding panel joint 42′ in the leg 30′ of the panel element 12. The arm elements 14, 14′ are releasable from the panel element 12, by “squeezing” the clips towards one another from the outside which releases them from engagement with lips of the square opening of the panel joint 42′. Preferably, the flat face defined by the base portion 48A of each arm member 14, 14′ faces the internal direction, or otherwise said, towards the other arm member, whereas the flanges 46A, 48A, 50A extend outwardly from the device 10. Therefore, both arm members 14, 14′, although similar, are in fact mirror images and necessitate different molds.

As it is shown in the drawings, the height at which the arm elements 14, 14′ separably connect the panel element 12 is located towards the lower portion of the panel element 12, towards the feet 34, 34′. This is preferred because it provides a greater lever to oppose pivoting forces on the panel member 12, and therefore provides increased rigidity. The stability of the structure is also provided by the spaced apart configuration of the arm elements 14, 14′ both on the panel element 12 and on the second rung 22′.

The standard height between rungs of various ladders is of 12 inches (0.305 m). However, the width of the ladder, determined by the length of the rungs does change, especially in certain applications like the electricians' fiberglass ladders which tend to be less wide than other types of ladders. To increase the stability of the device, widening the spacing between the two arm elements 14, 14′ is desired, however, this is limited by the desire to accommodate most types of ladders. Therefore, the spacing of the arm elements 14, 14′ along the rung 22′ is preferably maximized within the limit determined to be the spacing corresponding to the smallest width of ladder it is desired the standoff device 10 be adapted to. Setting the joint between the arm elements 14, 14′ and the panel element 12 directly at the bottom, like within the feet, for example, was not found as advantageous as setting the joint location at an intermediate height within the legs 30, 30′. In the latter configuration, the preferred triangular shape of the panel element 12 let the feet extend wider than the spacing of the arms, which provides greater stability upon the work surface.

To strengthen the joint 40, 42, the arms have been designed with a wider base portion 58 and a thinner attachment portion 56, this is particularly illustrated in the bottom view of FIG. 4B. Therefore, it can be said that the main portion of the arm elements 14, 14′, between the attachment portion 28′ and the arm joint 40′, is of a somewhat V shape, with the thinner end of the V coinciding with the thin portion 56, and the wide end of the V coinciding with the wide portion 58. It is also seen that one wing of the V extends at 90° from the panel element 12, whereas the other wing of the V is slanted. This provides the additional width of the wide portion towards the outside, in the direction the flanges 46A, 50A face. Of course, this makes the flanges 50A, 46A of the preferred arm member 14′ of varying height. Since the additional width extends towards the outside, the attachment portions 28, 28′ are maintained in a spaced apart configuration adapted to fit the ladders of smallest width desired, whereas additional rigidity is provided to the arm-panel joint 42, 40.

A further alternative which may be readily imagined is to provide a structural element which is not of a generally triangular shape. For example, the structural element could be much more trapezoidal in shape and have a wider panel attachment which could consist of several individual attachments. This could add weight to the device and is not preferred.

The illustrated design is preferred because it has a high rigidity and a low overall weight and cost due to its minimized quantity of material. The entire structure is molded in the different parts mentioned, which are preferably all of polypropylene.

Typically, when using the standoff device 10 to space the ladder 18 from a vertical wall, the standoff device is installed to the second and third rungs of the ladder 18. When the standoff device 10 is used to space the ladder 18 from a roof edge, whether the roof is horizontal or inclined, the standoff device may be installed on rungs located further down, leaving more of the ladder 18 extending passed the roof. However, this is practically limited by the length of the ladder 18 being used.

As previously discussed, the preferred standoff device 10 is also advantageous because it allows the use of a tray or container (not illustrated) on and between its two arm elements 14, 14′. Such a tray has a minimized thickness to minimize weight and cost, and has a shape to adapt onto the arms which are in place. This is preferably provided by the tray having two laterally extending shoulders which lay against the upper surface of the arms. Preferably, the tray has an horizontal ledge extending from the upper side of the tray, toward the user, the ledge having four holes therein to receive screwdrivers or the like.

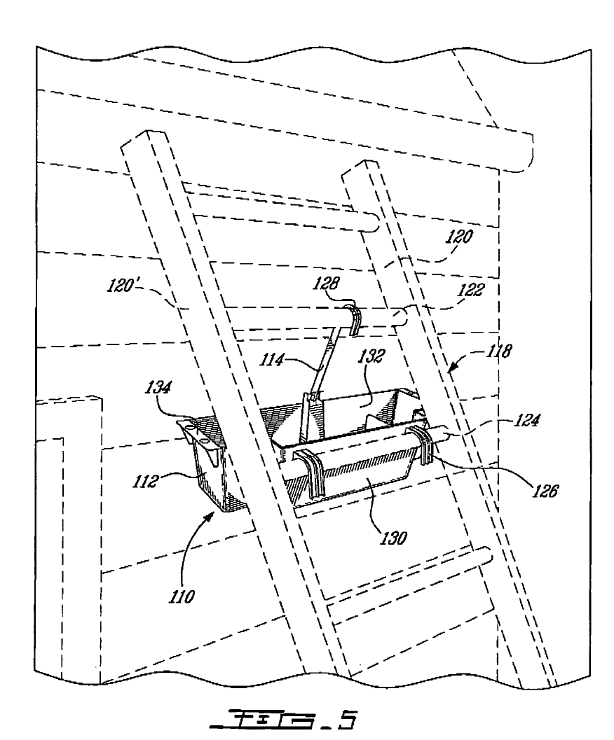

With reference to FIGS. 5 to 7, a container is illustrated for use with a ladder, in accordance with a preferred embodiment.

FIG. 5 illustrates the container 110 in use, suspended from rungs of a ladder 118. The ladder container 110 has two main components: a receptacle element 112 and an arm 114.

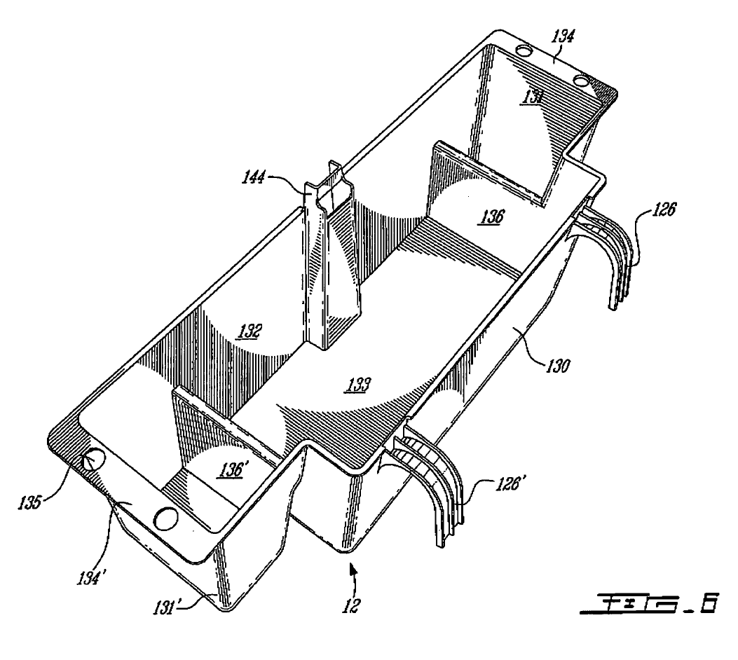

The receptacle element 112 is best illustrated in FIG. 6 which shows it has two curved members 126, 126′ on its front wall 130, toward the upper side thereof, which are spaced apart along the wall to provide a stable attachment along a lower rung of the ladder 118. For mounting the tray to a ladder, the curved members 126, 126′ are mounted onto a lower rung 122′ of the ladder. The receptacle element 112 also has a shank portion 144, disposed transversally and positioned upwardly from the center of the rear wall 132 of the container 110. The receptacle element 112 may either be a simple receptacle, or may optionally include separators 136, 136′ or flanges 134, 134′ with holes 135 to place tools, as illustrated.

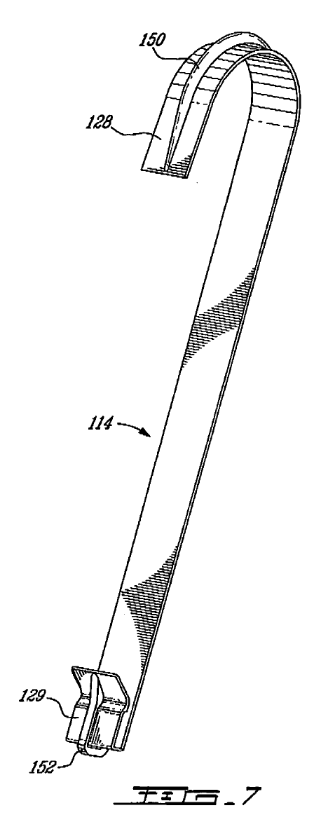

The arm is best illustrated in FIG. 7, which shows it has a rung hook 128 for securing to a rung at one end, and a shank hook 129 for securing to the shank at the other end. Preferably, the rung and shank hooks 128, 129 are of simple curved shape, which allows easy assembly and disassembly from the rung and shank portion 144. When securing the container to a ladder, leaving the receptacle element mounted to the lower rung 122′ would make the weight of the receptacle element pivot the latter around that rung. The arm 114 is therefore secured to the shank portion of the container, and the rung hook 128 of the arm 114 is secured onto an upper rung of the ladder. Both parts are easily assembled and disassembled for use and storage in an instant. In certain applications, the arm may even be stored within the container. Further, the components are lightweight and provide a suspended container at low cost. Both the arm 114 and the receptacle element of the suspended container are preferably molded of polypropylene. As it is seen in FIG. 7, the rung and shank hooks 128, 129 are reinforced by a molded flange 150, 152 extending radially from each one.

The embodiments of the invention described above are intended to be exemplary only. The scope of the invention is therefore intended to be limited solely by the scope of the appended claims.

What is claimed is:

1. A molded standoff device for spacing a ladder from a work surface, the device comprising:
a structural panel element having
a panel attachment securable onto a first rung of the ladder, and
at least two work surface contact areas spaced apart along a transverse axis to said ladder, opposite the panel attachment; and
at least one structural arm element separably connected to the panel element and having an attachment portion securable onto a second rung of the ladder such that the standoff device will be rigidly secured to the ladder.

2. The device claim 1 wherein:
the panel element is of a generally isosceles triangular shape having opposed apex and base, with the base coinciding with the transverse axis and the apex corresponding with the panel attachment.

3. The device of claim 2 wherein:
the base of the panel element curves inwardly defining an arch between two legs of the panel element, each leg having one of the work surface contact areas, such that the device may be used against a corner of two intersecting work surfaces with the corner engaging within the arch.

4. The device of claim 3 comprising:
two said arm elements, each secured to a corresponding leg and onto the second rung by respective attachment portions, the attachment portions being spaced apart one another along the second rung.

5. The device of claim 1 wherein each said work surface contact area is formed as a semi-circular foot, said semi-circular foot spanning at least 90 degrees such that a portion of the contact area faces the work surface when the device is in normal use, whether the work surface is a vertical wall or a horizontal roof.

6. The device of claim 1 wherein the panel member has a panel joint for each at least one arm member, and said at least one arm member has a arm joint for snappingly engaging said panel joint.

7. The device of claim 1 wherein the panel member and each at least one arm members are molded of polypropylene, and comprise a flat base with a plurality of flanges extending therefrom thus providing a body portion thereof where the structural rigidity is maintained while reducing the necessary amount of polypropylene.

8. The device of claim 1 wherein at least one of the panel attachment and the arm attachment portion comprises:
a straight strip with a catch defined at a free end thereof;
an outwardly curved strip with a hook defined at a free end thereof; and
an engagement area defined between the straight and curved strips;
whereby the rung is receivable in said engagement area, and the hook releasably and snappingly engageable with the catch, thus achieving said securability.

9. The device of claim 4 further comprising a tray engaged onto and between the arm elements.

10. The device of claim 1 wherein the first rung is immediately adjacent the second rung, and above the second rung when the ladder in an upright operating position.

11. A molded container for use on a ladder, comprising:
a receptacle element;
at least one attachment for securing a first wall of the receptacle to a lower rung of the ladder;
an arm, separable from the receptacle element, for securing a second wall of the receptacle, opposite the first wall, to an upper rung of the ladder;
whereby the receptacle is stably suspended to said rungs of the ladder by the arm and the receptacle attachment when the ladder is in use.

12. The container of claim 11 wherein the receptacle comprises a shank portion at the middle of the upper side of the second wall, and the arm comprises a shank hook at one end and a rung hook at the other end, the shank hook being engaged to the shank portion, and the rung hook being engaged onto the upper rung.

13. The container of claim 11 wherein the at least one attachment consists of two curved members, laterally spaced along an upper side of the first wall, and extending from the container body, the curved members being engaged onto the lower rung.

14. The container of claim 11 wherein both the receptacle, its attachment, and the arm are molded out of polypropylene.

15. The container of claim 11 wherein the container body comprises
at least one wing member extending laterally from an upper end of a side of the receptacle, having at least one aperture defined therethrough for receiving a tool or the like.

16. The container of claim 15 wherein the container body comprises
one wing member extending laterally from each of two lateral sides of the receptacle, each wing member having 2 apertures of a size allowing reception of a screwdriver.

17. A removable standoff device for a ladder comprising:
a standoff device body having
a first attachment means for removably attaching the standoff device body onto a rung of the ladder and
at least two abutting means spaced apart along an abutment axis, for abutting against a work surface; and
arm means secured to the standoff device body, between the first attachment means and the abutting means, for rigidly securing the standoff device body to another rung of the ladder,
whereby the abutment axis is maintained spaced from the ladder by the standoff device.

18. The device of claim 17 wherein the arm means are separable from the standoff device body, and both the arm means and the standoff device body are molded of polypropelene.
